(19) United States
(12) Patent Application Publication
(10) Pub. No.: US 2015/0323173 A1
(43) Pub. Date: Nov. 12, 2015

(54) BUTTER LAMPS WITH WICK HOLDER

(71) Applicants: Vivek Sinha, Blaine, MN (US); Shilpi Sinha, Blaine, MN (US)

(72) Inventors: Vivek Sinha, Blaine, MN (US); Shilpi Sinha, Blaine, MN (US)

(21) Appl. No.: 14/270,506

(22) Filed: May 6, 2014

(51) Int. Cl. F21V 37/00; F23D 3/24

(52) U.S. Cl. CPC F21V 37/0004; F23D 3/24; F21V 37/002; F21V 37/0095

(57) ABSTRACT

The “Butter Lamp” with a unique wick holder to maximizes the efficiency of the lamp. The wick holder is made of metal which regulates the temperature to melt the ghee (a class of clarified butter) or any other fuel. The wick holder stops the wick from floating to the top of the molten ghee (a class of clarified butter) and burning before the ghee/fuel does. The top of the wicks which is twisted along with camphor helps to ignite fast and also it gives a nice fragrance.

### FIELD OF THE INVENTION

This invention generally relates to readymade Butter lamps, and more particularly a cotton wick metal holder which normalizes the temperature of frozen Ghee (a class of clarified butter that originated in India and is commonly used in South Asian cuisine and ritual).

### BACKGROUND OF THE INVENTION

A Butter lamp, is not truly a “candle” in a traditional sense because the Butter lamp does not comprise a wick without a holder and a flammable fuel is not Wax. Ghee (a class of clarified butter) is used for producing flame. Instead, a Butter Lamp, a light-emitting lamp that resembles a Diya are native to India, is are often used in Hindu, Sikh, Jain and Zoroastrian religious festivals such as Diwali or the Kushti ceremony. A similar lamp is used in Tibetan Buddhist offerings as well. A butter Lamp includes a wicks holder not only for holding the wicks but also for regulating the temperature for lighting up the Lamp. Typical melting point for ghee (a class of clarified butter) is around 95° F. to 104° F. Typical smoking point for ghee (a class of clarified butter) is around 375° F. The ghee starts to solidify below 63° F. and ghee freezes near −4° F.

### BRIEF SUMMARY OF THE INVENTION

An object of the present invention is to provide an innovative and or improved “Butter lamp” that would meet the demand in the market, in particular for those families living in the U.S.A and following Hindu religion.

The “Butter Lamp” with a unique wick holder maximizes the efficiency of the lamp. The wick holder made of metal is particularly important as it regulates the temperature to melt the ghee (a class of clarified butter). The wick holder stops it from floating to the top of the molten ghee (a class of clarified butter) and burning before the ghee does. The top of the wick is twisted along with camphor, which helps it to ignite fast, and also it gives a nice fragrance. Camphor is widely used in Hindu religious ceremonies. Hindus worship a holy flame by burning camphor, which forms an important part of many religious ceremonies.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a Perspective View of the Butter lamp.

FIG. 2 is a Top View of the Wicks Holder.

FIG. 3 is a Wicks Holder view from Side 1 (Say North).

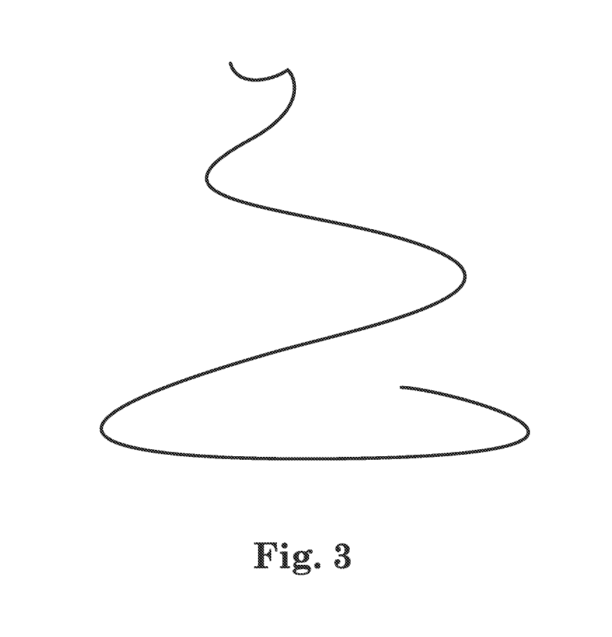

FIG. 4 is a Wicks Holder view from Side 1 (Say East).

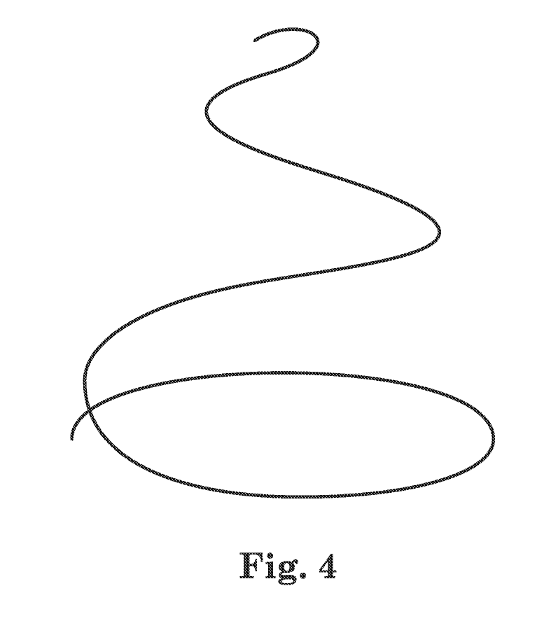

FIG. 5 is a Wicks Holder view from Side 1 (Say South).

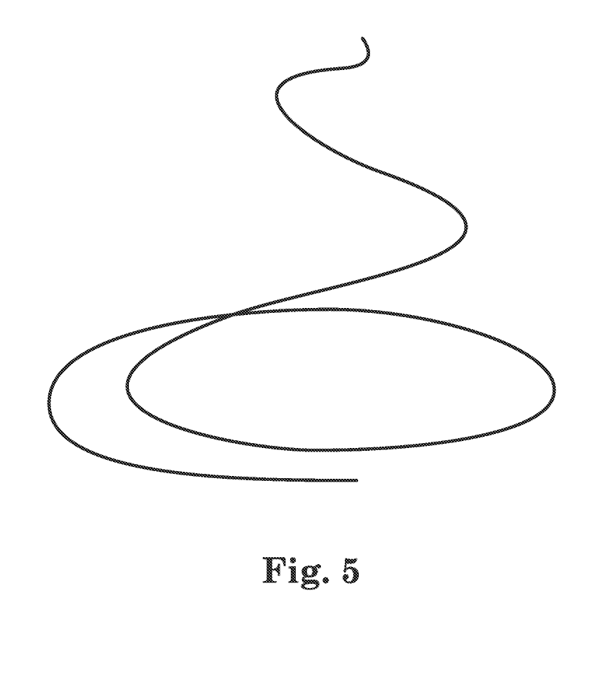

FIG. 6 is a Wicks Holder view from Side 1 (Say West).

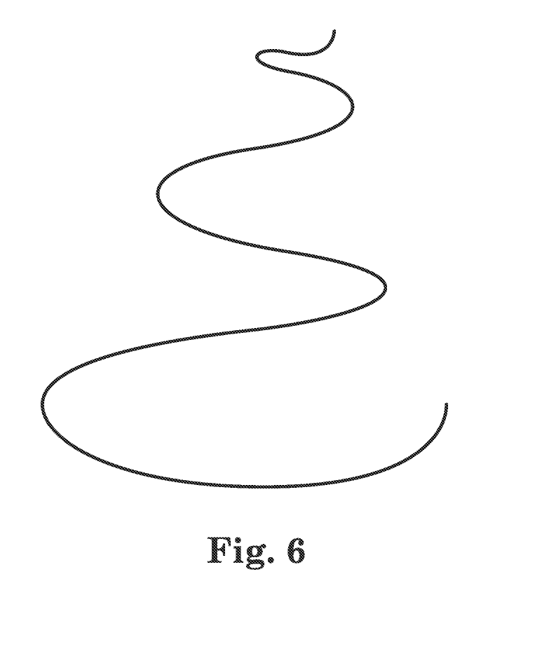

FIG. 7 is a bottom up view of the Wicks Holder.

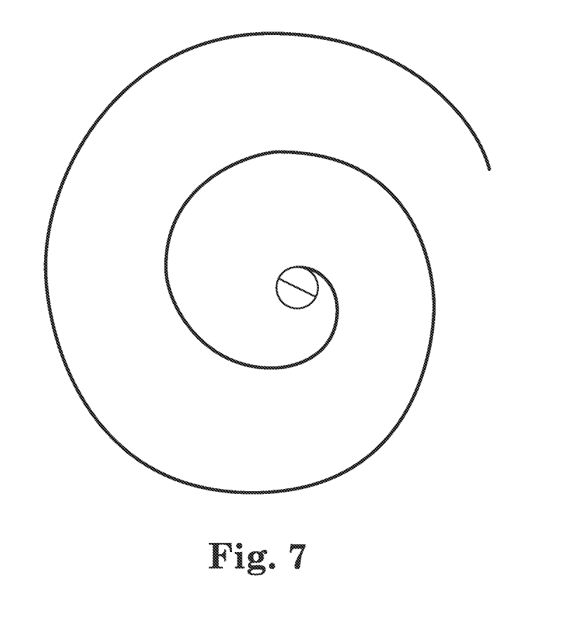

FIG. 8 is longitudinal view of the wick holder with wicks.

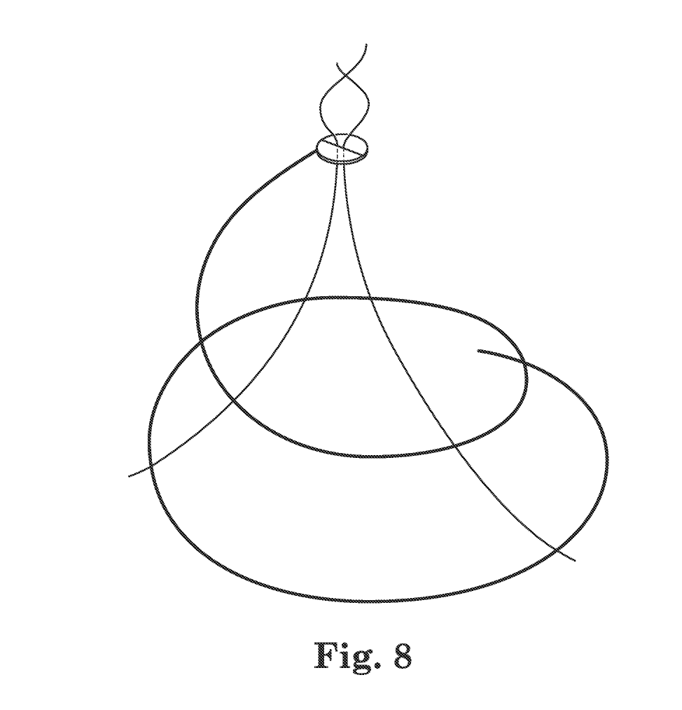

### DETAILED DESCRIPTION

Product Details

The list of the raw materials, sub-assemblies, intermediate assemblies, sub-components, parts and the quantities of each needed to manufacture A Butter Lamp:
Specially designed Metal Wick holder: Quantity of ONE
Wicks: a braided cotton/cotton or other suitable material that holds the flame of a Lamp and twisted at the top of the Wick Holder: Quantity of at least ONE
Camphor: Pinch of it at the Tip of wicks
Fuel: Scented Ghee, is essentially clarified butter with different kind of fragrance: Quantity -varies
The Container/Cup: Quantity of ONE

Storage Temperature for this finished Product: Ideal temperature is below 63° F.

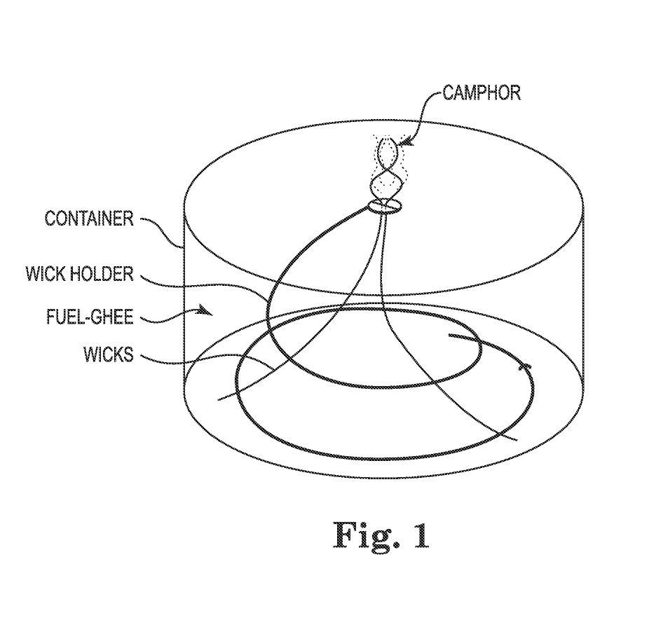

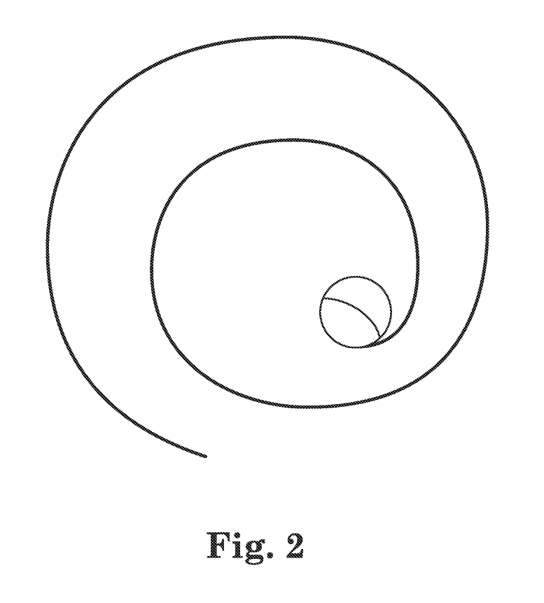

Details of Sub-Assemblies:
Metal Wick holder: It's specially designed Metal, which holds the wicks & regulates the temperature. The metal used is Solid wire, also called solid-core or single-strand wire, and consists of one piece of metal wire. The wire materials are Copper, Aluminum, Iron or steel. These material are used due to their heat conductor capability. The gauge of the wire can be between 11-28 mm.
The wick holder is formed (twisted into a spiral formation with largest diameter at the base to sit within the container/cup and gradually decreasing diameter as the spiral extends upward toward the flame). The larger diameter at the base helps to soften the fuel which is farthest from the flame via heat conduction, which is enabled from the metal wicks holder. The top of the wicks holder which is partitioned [Refer to FIG. 2] holds wicks from both sides. This creates a gap in the wicks, which helps to get the air, enabling quicker and consistent flame.
   Purpose of the sub-assemblies : It holds the wicks for a period till all fuel is burnt & more importantly passes on the higher temperature to the bottom, which enables the fuel to burn more efficiently.
Wicks : A braided cotton/cotton braided cotton or other suitable material that holds the flame of lamp. Important characteristics of the wick include stiffness, fire-resistance, and tethering. The wicks goes down along with Wicks holder, which in turn gets the higher temperature , thereby enabling the better flame.
   Purpose of the sub-assemblies A wick works by capillary action, conveying (“wicking”) the fuel to the flame. When the liquid fuel reaches the flame it then vaporizes and combusts. The wick influences how the butter lamp burns.
Camphor: is a waxy, flammable, white or transparent solid with a strong aromatic odor.
   Purpose of the sub-assemblies : Helps in Igniting the Butter lamp along with the fragrance.
Fuel: Ghee is essentially clarified butter that is cooked a bit longer until the clarified butter is golden and the milk solids at the bottom are toasted (but not burnt). This could work with other fuels as well, such as other solid or liquid fuels.
   Purpose of the sub-assemblies : Fuel, along with different fragrance.
The Container/Cup: an object that can be used to hold the fuel. It can be of either metal, glass or mud. The container/cup is cylindrical in shape with top open that holds the liquid, Refer to FIG. 1. The container does not just hold the fuel, but also has a Wicks holder attached to it.

We claim:

1. A lamp comprising:
a fuel substance that fuels a flame;
a container that holds the fuel substance;
one or more wicks; and
a wick holder within the container, the wick holder comprising metal wire;
wherein the one or more wicks are coupled to the wick holder, the wick holder holding the one or more wicks substantially in place within the fuel substance;
wherein the wick holder is placed within the container such that it distributes heat from a flame throughout the fuel substance.

2. The lamp of claim 1, wherein the fuel substance is clarified butter.

3. The lamp of claim 2, wherein the fuel substance is ghee.

4. The lamp of claim 1, wherein a portion of each wick is coated in camphor.

5. The lamp of claim 1, wherein the wick is comprised of braided cotton.

6. The lamp of claim 1, wherein the wick holder is comprised of at least one of copper, aluminum, iron, and steel.

7. The lamp of claim 1, wherein the wick holder is readily removable from the container.

8. The lamp of claim 1, wherein the wick holder is an elongated spiral shape, wherein a base of the wick holder has the largest diameter portion, the diameter of the wick holder decreasing as the spiral extends upward toward the top of the wick holder, where the one or more wicks are coupled to the wick holder.

9. A wick apparatus for a lamp, the apparatus comprising:
one or more wicks; and
a wick holder, the wick holder comprising metal wire;
wherein the one or more wicks are coupled to the wick holder, the wick holder holding the one or more wicks substantially in place within a fuel substance;
wherein the wick holder is placed within the fuel substance such that it distributes heat from a flame throughout the fuel substance.

10. The wick apparatus of claim 9, wherein a portion of the wick is coated in camphor.

11. The wick apparatus of claim 9, wherein the wick is comprised of braided cotton.

12. The wick apparatus of claim 9, wherein the wick holder is comprised of at least one of copper, aluminum, iron, and steel.

13. The wick apparatus of claim 9, wherein the wick holder is an elongated spiral shape, wherein a base of the wick holder has the largest diameter portion, the diameter of the wick holder decreasing as the spiral extends upward toward the top of the wick holder, where the one or more wicks are coupled to the wick holder.

14. A method of making a lamp, the method comprising:
obtaining a fuel substance that fuels a flame;
placing the fuel substance in a container;
using metal wire to form a wick holder, wherein the wick holder is placed within the container and extends to the bottom of the container; and
coupling one or more wicks to the wick holder.

15. The method of claim 14, wherein the fuel substance is clarified butter.

16. The method of claim 15, wherein the fuel substance is ghee.

17. The method of claim 14, wherein a portion of each wick is coated in camphor.

18. The method of claim 14, wherein the wick holder is comprised of at least one of copper, aluminum, iron, and steel.

19. The method of claim 14, wherein the wick holder is readily removable from the container.

20. The method of claim 14, wherein the wick holder is an elongated spiral shape, wherein a base of the wick holder has the largest diameter portion, the diameter of the wick holder decreasing as the spiral extends upward toward the top of the wick holder, where the one or more wicks are coupled to the wick holder.
